(19) United States
(12) Patent Application Publication
(10) Pub. No.: US 2007/0021212 A1
(43) Pub. Date: Jan. 25, 2007

(54) Persistent and effecient game architecture

(76) Inventors: Derek Liu, Milpitas, CA (US); John Loethrer, Scotts Valley, CA (US)

Correspondence Address: XIN WEN, 3449 RAMBOW DRIVE, PALO ALTO, CA, 94306, US

(21) Appl. No.: 11/188,148

(22) Filed: Jul. 22, 2005

(51) Int. Cl. A63F 13/00

(52) U.S. Cl. 463/40

(57) ABSTRACT

A network-based game system includes a computer network, and a first server and a second server connected to the computer network. The first server is configured to store a game engine application that can communicate with a game client application running on a computer device connected to the computer network in a persistent network connection. The second server is configured to store a game-system-interface (GSI) program that can respond to requests from the game client application running on the computer device in a non-persistent network connection.

### TECHNICAL FIELD

This application relates to a game system, more specifically, a network-based game system.

### BACKGROUND

Interactive online digital entertainment has advanced on many fronts in recent years, especially with respect to video gaming. For example, users can login to websites to find an opponent and then a game of chess or a card game in the virtual world. As a player may be competing against another player, the communication is bi-directional. However, not all video games can be played online. For a game of chess where time to make a move does not have an immediate and consequential effect on the outcome, players have time to contemplate the next move, counter move, game strategy and so on and the game does not need to provide real-time feedback. However, in a majority of real-time video games, time needed to make a decision and act upon that decision is relatively short so that players involved feel a sense of realism and engagement. In such a real-time game, action must occur in close proximity to real life events. Real-time action is required for the action games, simulation games such as flight simulators and sport games. In most cases persistent communications, scoring, player attributes, etc. cannot be offered together with real-time realism and engagement.

A further challenge to the network-based game application is scalability. While some existing network-based systems can handle tens of thousands of game players, it is a serious challenge to provide game applications in real time to millions of players reliably and simultaneously.

### SUMMARY

Implementations of the system may include one or more of the following. In one aspect, the present invention relates to a network-based game system, comprising:
a computer network;
a first server connected to the computer network, configured to store a game engine application that can communicate with a game client application running on a computer device connected to the computer network in a persistent network connection; and
a second server connected to the computer network, configured to store a game-system-interface (GSI) program that can respond to requests from the game client application running on the computer device.
In another aspect, the present invention relates to a game architecture, comprising:
a computer network to be connected to a computer device capable of executing a game client application;
a first server connected to the computer network, configured to store a game engine application that can
a) respond to the game client application instantaneously after receiving a request from the game client application and
b) send a request to the game client application and instantaneously receive a response from the game client application; and
a second server connected to the computer network, configured to store a game-system-interface (GSI) program that can respond to the requests from the game engine application and can receive game information from the game engine application in a non-persistent network connection.

In yet another aspect, the present invention relates to a method of providing a game over a computer network, comprising:
storing a game engine application on a first server connected to the computer network;
communicating between the game engine application and a game client application running on a computer device connected to the computer network in a persistent network connection;
storing a game-system-interface (GSI) program on a second server connected to the computer network; and
responding to requests from the game client application by the GSI program.

Implementations of the system may include one or more of the following. The game-system-interface (GSI) program can be configured to communicate with the game client application running on the computer device in a non-persistent network connection. The game engine application can be configured to be connected with the game client application are in an open socket connection to allow messages to be instantaneously communicated between the game engine application and the game client application. The game client application can be executed by a plug-in to a web browser installed on the computer device. The game client application can use the web browser's API to communicate with the game engine application and the GSI program. The game client application can be configured to display vector-graphic animations independent of the web browser used and can scale vector-graphic animations relative to the size of the web browser window. The game engine application and the game client application can be configured to send requests to each other and instantaneously respond to the requests. The game engine application can be configured to send animation information to the game client application. The GSI program can be configured to receive game status information from the game client application running on the computer device. The game status information can include one or more of user identification, session identification, game room information, game statistics, and game configurations associated with a game client application running on the computer device. The network-based game system can further comprise a data storage system connected to the computer network, configured to store the game status information received from the GSI program. The GSI program can be configured to send a verification message to the game engine application or the game client application in response to authentication information received from the game engine application or the game client application. The game engine program can be configured to send identification information to the GSI program in response to the authentication information received from the game client application. The identification information includes one or more of user identification, game session identification, and game room identification. The game engine application and the GSI program can be configured to communicate with the game client application in serialized messages encrypted under one or more serialization protocols. The network-based game system can further comprise a computer device connected to the computer network, configured to store a library of encryption rules and decryption rules to be used to encrypt and decrypt the serialized messages between the game engine application and the game client application and between the GSI program and the game client application. The library of encryption rules and decryption rules can include a plurality of message serialization communication protocols.

Embodiments may include one or more of the following advantages. An advantage of the present invention is that the disclosed system can provide game applications to remote game players with persistent network connections while efficiently tracking and updating the game status of each of the players in an efficient manner. The disclosed system includes a persistent communication path that provides instantaneous message exchanges for the game applications in real time. The disclosed system includes a separate communication path that can respond to the requests game applications without consuming significant network resources and store game status information in storage devices.

Another advantage of the present invention is that the disclosed system is network based and can provide game applications simultaneously to many remote game players. The players can play the games at locations convenient to them. Many game players can play the same game applications while competing against each other or play separate game applications. The persistent communication paths allow game applications to be played without network latency at multiple remote locations.

Yet another advantage of the invention is that the disclosed game system is efficient. The disclosed game system includes a communication path to the game client that does not need to be persistent through a game session. A call from the game client is answered and the communication session is closed and network connection freed up.

Because of its efficient communication architecture, the disclosed system can be scaled up easily without consuming significant network bandwidth as in the prior art systems. It can host millions of game players in millions of game sessions over a computer network, which is one or more orders of magnitudes higher than conventional network-based game systems.

Still another advantage of the invention is that the disclosed system can provide many game applications to remote game players over a computer network using different serialization encryption protocols such as PHP, XML, AMF, XML-RPC, etc. The game players can access game applications based on any of the protocols from a single network-based service. The selection of the game applications is significantly increased.

Another advantage of the present invention is that it allows scalability to the hosting of a large number of game players in the same game room or in different game rooms. The communications to the game client application are divided into a persistent communication and an efficient but non-persistent communication path. The amount of information communicated in real time is minimized. A flexible layer by game-system-interface (GSI) program handles the non-persistent communications, which allows the network-based game system to handle a large number and variety of game client applications.

The details of one or more embodiments are set forth in the accompanying drawing and in the description below. Other features, objects, and advantages of the invention will become apparent from the description and drawings, and from the claims.

### BRIEF DESCRIPTION OF THE DRAWINGS

FIG. 1 is a system diagram of the network-based game system in accordance with the present invention.

FIG. 2 shows a game client application that can be running on a computer device shown in FIG. 1.

FIG. 3 shows a game engine application that can be stored on a game server shown in FIG. 1.

FIG. 4A shows a Game System Interface application that is stored on a server in the network-based game system shown in FIG. 1 in accordance to an embodiment of the present invention.

FIG. 4B shows a Game System Interface application that is stored on a web server of FIG. 1 in accordance to another embodiment of the present invention.

FIG. 5 shows a system diagram of a persistent and efficient game architecture in the network-based game system of FIG. 1.

### DETAILED DESCRIPTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

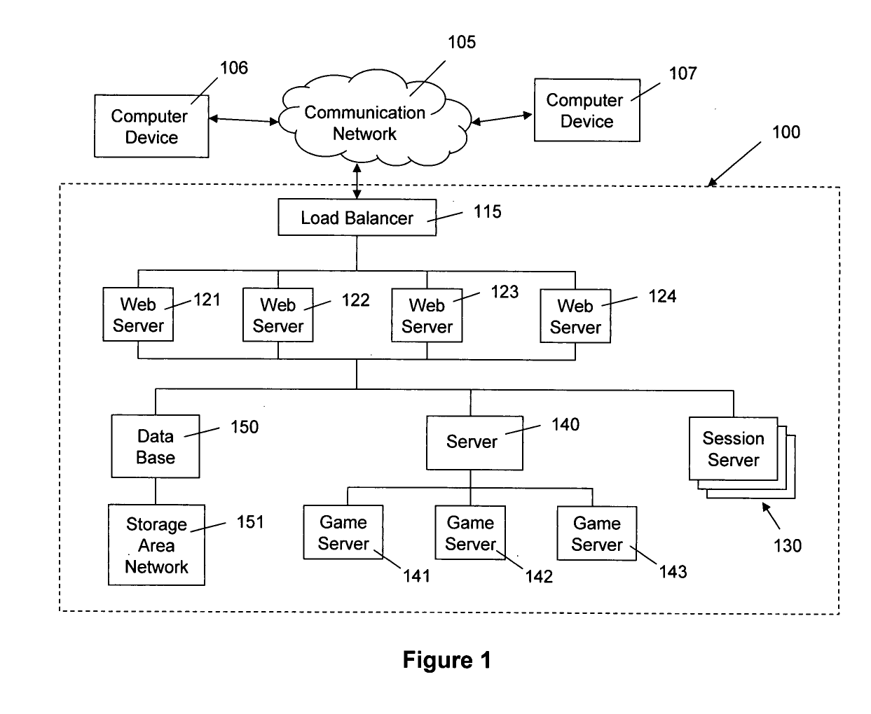

Shown in FIG. 1, a network-based game system 100 can provide game applications over a communication network 105 to be played on many computer devices 106 and 107. The communication network 105 can include various wired, wireless, satellite communication arrangements including but not limited to a wide area network such as the Internet, a local area network, a cellular phone network under various communication protocols such as 2G, 2.5G and 3G, Global System for Mobile Communications (GSM), General Packet Radio Service (GPRS), EDGE, Code Division Multiple Access (CDMA), Wideband CDMA, TD-SCDMA, Universal Mobile Telecommunications System (UMTS), etc., and Wi-Fi wireless communication standards such as IEEE 802.11, Wi-Max, and IEEE 806.16, and others. The computer devices 106 and 107 can include personal computers, portable digital assistance (PDA) devices, cell phones, digital image capture devices, and dedicated game devices such as Microsoft XBOX, the SONY PlayStation OR PS2, and/or the Nintendo 64, GameCube, or GameBoy.

The network-based game system 100 can include a load balancer 115, one or more web servers 121-124, one or more session servers 130, a server 140, one or more game servers 141-143, a database 150, and a storage area network 151. The network-based game system 100 can be operated by a game service provider such as Gaia Interactive Inc., based in California, USA. The network-based game system 100 can provide a website such as www.gaiaonline.com on the Internet to host a game community and provide various game services such as games, discussion groups, and mails etc. A player can sign up at the website to own his or her own account. The player can also personalize his or her own profiles. As described below, the network-based system 100 can store game statistics and other game properties associated with a player in a networked storage device, available and updatable to the game player.

A game player can access the web site of the game service provider using computer devices 106 and 107 with a web browser application executed on the computer devices 106 or 107. The web browser applications are available from several manufacturers including Internet Explorer™ from Microsoft, Netscape™ from AOL, and Firebox™ from Mozilla and so on. Various Internet browsing applications are available to cellular phones, PDAs, game consoles, which are also compatible with the disclosed system and methods.

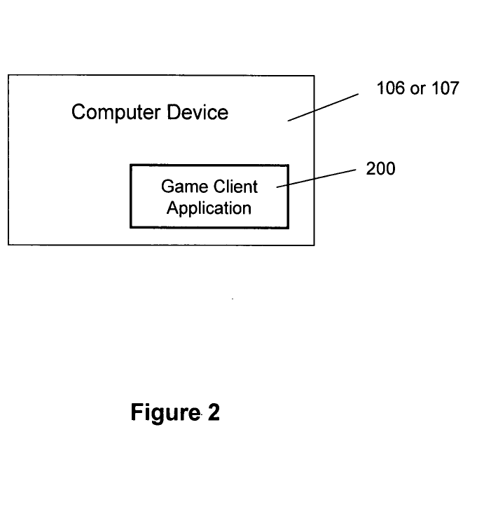

A game client application 200 can reside on the computer device 106 or 107 as shown in FIG. 2. The game client application 200 can be executed by a plug-in to the web browser application. The game client application 200 can include game logic for one or more games and enable animation display for the games. The web-browser plug-in can enable the web browser to audio or video messages and properly display vector graphics images independent of the manufacturer or the version of the web browser. The web-browser plug-in can allow animations to be properly scaled to as web browser window is resized. The game client application 200 can use the web browser's communication API (Application Programming Interface) to communicate with various servers and devices (115, 121-124, 140-143 etc.) in the network-based game system 100.

Specifically, without limitation, the computer devices 106 and 107 can be installed with Flash plug-in produced by Macromedia Inc. Flash is a bandwidth friendly and browser independent vector-graphic animation technology. Animation is choreographed using one or more sequential timelines in which actions and interactions are defined. The Flash plug-in is attached to the web browsers running on the computer devices 106 and 107 to allow the web browser play SWF (Small Web Format) movie clips referenced in a webpage. Macromedia's Flash MX and Freehand applications and other Flash files can also be viewed through a Web browser plug-in (or the Flash player) or multimedia applications that access the player directly. Flash files can include sound. Flash can use the FLA files for source files and SWF files for the Flash movies. Flash files are space-efficient and suitable for interactions, comparing to other movie files (AVI, MPG, etc.) files.

The game client application 200 can be written in one or more SWF movie clips to be loaded in the web browser. Each game client application 200 can correspond to one or more games. The SWF movie clips include game logic as well as animations, images, and other effects. The SWF movie clips can communicate with servers in the network-based game system 100 using the library of functions provided by Macromedia's Flash plug-in. A library of APIs can be developed for the SWF movie clips that can be re-used in multiple games.

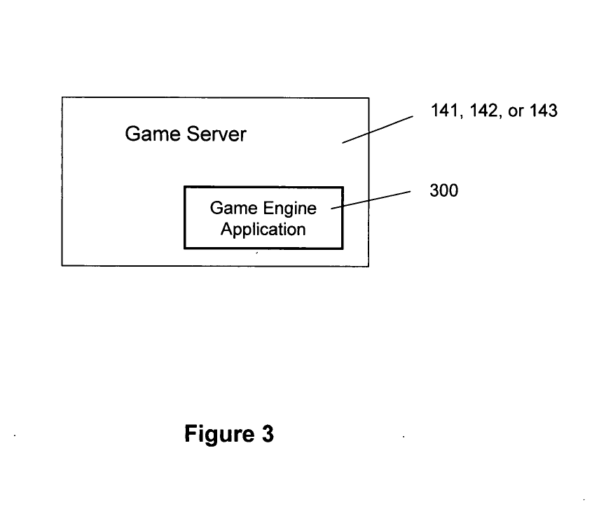

FIG. 3 shows a game engine application 300 stored on a game server 141, 142, or 143. The game engine application 300 is responsible for providing real-time responses to the game client application 200 during a game session. In the present application, the term “real-time communication” refers to the types of communications facilitated by a persistent network connection. The persistent network connection allows instantaneous and reliable communications between two components over the network without network latency.

The game server 141, 142, or 143 on which the game engine application 300 is stored can keep an open socket connection with the computer device 106 or 107. The game engine application 300 and the game client application 200 can send and receive TCP/IP messages to and from each.other by writing and reading data to and from the socket. Messages can be sent and received from either the game server 141 (or 142 and 143) or the computer device 106 or 107 at any time. The persistent network connection allows instantaneous two-way communications and guarantees the games updated in real time without network latency at all time during a game session. A loss of connection in the persistent communication can be interpreted as that the game client application 200 has left the game.

The game engine application 300 is compatible with different server software implementations such as Sushi Multiuser Server available at “www.wok2.de”, ElectroServer 3 available at “www.electrotank.com”, and Terazona Network Engine available at “www.zona.net”. The network-based game system 100 can include many the game engine applications 300 developed using different server software. Different server software may require serialized messages encrypted under different serialization protocols. The communication protocols with these game engine applications 300 are provided by the GSI program 400.

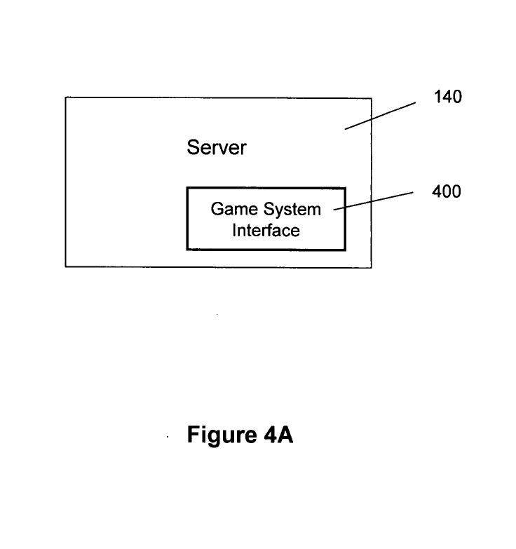

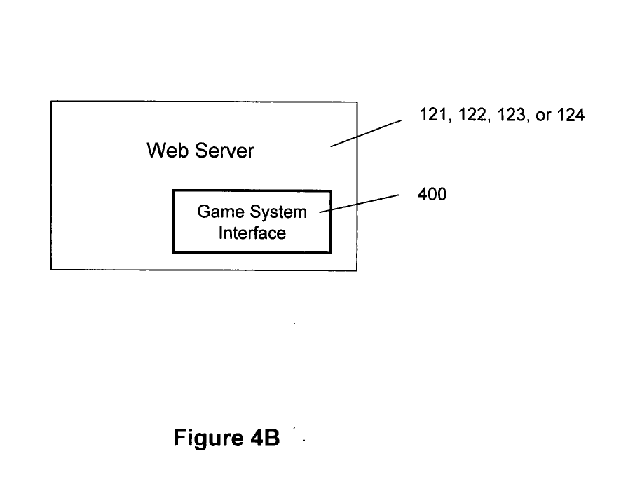

The network-based game system 100 includes a Game System Interface (GSI) program 400 that can be stored on a server 140 as shown in FIG. 4A, on the web server 121, 122, or 123 as shown in FIG. 4B, or on other servers such as the game servers 141-143 connected to the computer network. This server that the GSI program 400 resides on can be a single computer or a load-balanced cluster of servers. Each request to the GSI program 400 is an autonomous transaction and therefore does not require a persistent connection between the GSI program 400 and the other party (e.g. the game client application 200 or the game engine application 300).

The GSI program 400 provides information to clients such as the game client application 200 in response to requests but does initiate communications. The GSI program 400 can respond to the requests from the game client applications 200 running on the computer devices 106 and 107. Similarly, the GSI program 400 can also provide game information in response to the requests from the game engine application 300.

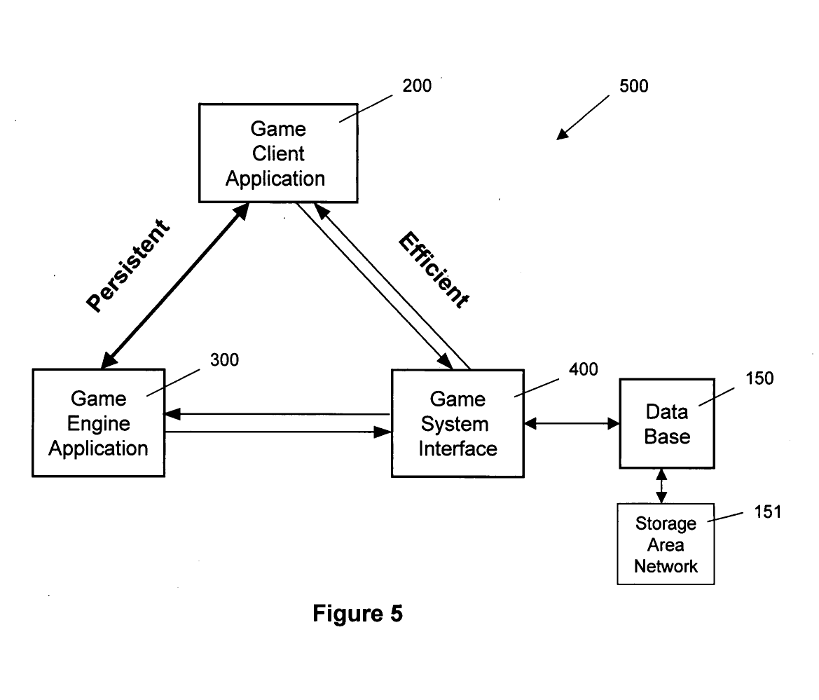

FIG. 5 shows a system diagram of a persistent and efficient game architecture 500 in the network-based game system 100. The persistent and efficient game architecture 500 include the game client application 200, the game engine application 300, and the GSI program 400, which provide a persistent communication path and an efficient but non-persistent communication path for the game client application 200. The GSI program 400 is connected to the database 150 and a Storage Area Network 151 for saving updated data in the current game and retrieving data from the current and past games. The games are run on the game client applications 200 and communicate with the game engine applications 300 through the protocols defined by the game client application 400.

An advantageous feature of the disclosed network-based game system is that it includes a persistent communication path and a non-persistent communication path for the remote game client application. The persistent communication path is used for exchanging short and instantaneous messages that a game needs to be updated in real time, but does not need to be stored permanently on data storage. The real-time two-way communications between the game client application 200 and the game engine application 300 are fast and without network latency. There is no cycle time spent on accessing and storing the exchange information on a data storage device. The persistency of the network connection between the game client application 200 and the game engine application 300 typically last through a game session.

The non-persistent communication path is efficient, which allows the amount of information communicated in real time to be minimized. As a result, the network-based system is scalable to a large number of game players. The non-persistent communication path is used to communicate information that is of “long-term” use to the games or the game players and does not require instantaneous and resource-intensive communications. The information may include the attributes and statistics of the game player such as his or her game scores, the equipment he or she purchased to be used in the games, the “money” he or she owns from the past and the current games, and so on. The information not only is needed for the current game, but also needs to be stored and retrieved for future games. Thus the information exchanged between the game client application 200 and the GSI program 400 often involves the access or retrieving data from the database 150 and a data storage device such as SAN 151, and writing and saving data to the database 150 and a data storage device. The interactions between the game client application 200 and the GSI program 400 are usually single requests that can be answered. The connection is then closed. In other words, no persistent network connection is required for these communications throughout a game session.

The persistent and efficient game architecture 500 shown in FIG. 5 differs from certain prior art systems that integrate the different types of communications into the same application layer. The same application layer handles real-time persistent communications and communications that do not need to be real time (which is in contrast to the separate game engine application 300 and the GSI 400 provided in the persistent and efficient game architecture 500). This type of prior art systems requires persistent network connections for both types of server communications throughout the game sessions. Each of the server instances is to be managed by a much larger and more resource-intensive application layer than the presently disclosed system. The burden to the application layer grows rapidly as the number of game clients or the number of games grows, which often increases the chance for failure, slows the responses, or degrades reliability. Furthermore, the present disclosed system is much more scalable compared to this type of prior art systems.

Each game engine application 300 can support one or many game client applications 200. The GSI program 400 can support many game client applications 200 and many game engine applications 300. The game logic can be stored inside the game client application 200, for example, in the form of compiled flash SWF files that are loaded on the web browsers on the computer devices 106 and 107.

The game client application 200 can be loaded via web browser running on the computer devices 106 and 107. The game client application 200 can include many game logics to allow a player to play many games. Alternatively, the game play logic can also be remotely stored on a server (such as 121-124 or 140-143) in the network-based game system 100. For example, the game logic can be included in the game engine application 300 or the GSI program 400 that can typically accommodate more complex game logic than game client applications. The remotely stored game logic can be activated remotely in real-time with secure processing on the servers (such as 121-124 or 140-143) or downloaded to the game players' computer devices 106 and 107 before a session starts.

To start a game, a game player can access a game service website such as www.gaiaonline.com operated by Gaia Interactive Inc., based in California, USA. The game player can initiate a game session by clicking a game client application 200 on a web page presented by a web browser application running on a computer device 106 or 107. In the present invention, a game session refers to an active connection between the client game application 200 and other programs such as game engine application 300 and GSI program 400 stored in the network-based game system 100. The game client application 200 can also be in the form of stream media (e.g. Flash SWF) so a game can keep loading as game-play starts.

In one embodiment, a game can be started and a game session can be initiated directly from the game client application 200 to the game engine application 300 after authenticating with GSI 400, without the need to access a webpage.

Many game client applications can be loaded on a computer device 106 or 107. Each game client application 200 can include game logic for one or more games. In one embodiment, the game client application 200 can be a Flash plug-in provided by Macromedia. The Flash plug-in can be downloaded, installed, and attached to a web browser. The Flash plug-in allows the web browser to play SWF movie clips in the web-browser it finds referenced in a webpage. Each SWF movie clip can include a unique game. The SWF movie clips contain the game logic as well as animations, images, and other effects. The SWF movie clip can communicate with servers in the network-based game system 100 using the library of fumctions provided by Macromedia's Flash plug-in and libraries of APIs developed for the network-based game system 100. Each game engine application 300 can support one or many game client applications 200 and thus many game logics.

During a game session, each game client application 200 can be supported by a game engine application 300 with a persistent connection in the network-based game system 100, that is, the game client application 200 and the game engine application 300 can send requests to each other and receive instantaneous responses at any time during a game session. A stop in the two-way communications between the game client application 200 and the game engine application 300 is typically interpreted by the game engine application 300 as the leaving of the game session by the game client application 200.

The network-based game system 100 can include many game engine applications 300 stored on the game servers 141-143. Each of the game engine applications 300 can be based on different game platforms that may be developed by the game service provider such as Gaia Interactive, Inc., or sourced from a third party game developer. The game player can thus access a wide range of network-based games at many game engine applications 300 that run on game platforms. Different game client applications 200 can be installed on the computer devices to run specific games supported by the corresponding game engine applications 300.

During a game session, the game client application 200 can pull information related to the specific game or game session from the game engine application 300. The game engine application 300 can respond to the requests instantaneously. The game engine application 300 can also update the game client application 200 with animations and short-term game information that do not need to be permanently stored. The short-term information, for example, can include the position of a soccer-ball on a field as it is being kicked around, the path a player's avatar is moving along on the field or the current pose an avatar is in, and the instant message chat communication between players in a game room, including text-based chats and emoticons.

In another embodiment, the network-based game system 100 can host many game players playing the same game client applications in a common game session. The game players can, for example, compete with each other in a ball game or fishing game in the game session. The game players playing can also be depicted as playing in the same game room. In the multi-player game sessions, the game engine application 300 can broadcast updates to many game client applications 200 running on many computer devices 106, 107 that are in the same game room.

The game engine application 300 can establish the players in the same game room as peers. The game engine application 300 can conduct peer-to-peer communications in real time by broadcasting a player's actions or events over that player's game client application to other peers' game client applications in the same game room. Each game client application 200 in the game room can construct a message and request the game engine application 300 to forward to the message another peer or all the peers in the same game room.

The GSI program 400 can respond to the requests from the game client application 200 running on the computer devices 106 and 107. The GSI program 400 typically answers questions but does not initiate requests by the game client applications 200. When a player enters the game website or when the player starts a game session, the game client application 200 requests an authorization from the GSI program 400. The GSI program 400 creates a new session ID for the user at login. The GSI program 400 verifies the user ID and session ID and returns validation message to authenticate the game session. The responses by the GSI program 400 in general do not need to be persistent. For example, they do not have to communicate through SOCKET connections. This flexibility allows a GSL program 400 to answer more calls and enables the network-based game system 100 to scale up and handle more game client applications and game players simultaneously.

The game client application 200 asks the GSI program 400 which game room to join for a given game. The GSI program 400 checks information received from the game engine applications 300 to see whether or not a game room has been created yet for that game. If the game room exists, the game client application 200 enters it. If the game room does not exist, the game client application 200 requests the game engine applications 300 to create one. The game engine application 300 creates the game room and passes the information to the GSI program 400 for verification. The GSI program 400 validates and returns a verification message including a new game room ID to the game engine application 300 that in turn returns the verification information to the game client application 200. The game client application enters the new game room. In this sequence of the communications, the GSI program 400 does not initiate the request. It only validates the information in requests it receives.

After the game engine applications 300 creates the game room, it writes information about the game room back into the GSI program 400 and waits for the GSI program 400 to validates that the game room is OK. After receiving the validation from the GSI program 400, the game engine application 300 allows the game client application to enter the new game room.

The game client application 200 then requests the load of the game. For example, a SWF file is loaded by the plug-in at the request of the web browser. The SWF is executed by a Flash Plugin. Instructions inside the SWF tell it to connect to the GSI program 400. Instructions inside the SWF also instruct it to display the game environment and run the game interactions.

The GSI program 400 returns the variables necessary for loading the game and information for saving game results to the game client application 200. During the game session, the game client application 200 can request the saving of the game results. The GSI program 400 validates the data to be saved and returns whether or not the saving is succeeded. The GSI program 400 also gathers information about all the players in the same game room and broadcast the information to the game room. In general, the GSI program 400 can respond to hundreds of different types of calls by the game client applications 200. The GSI program 400 can typically communicate with game client application 200 in the range of 0.001-0.1 milliseconds depending on network latency and the processing time. The priority for the performance of the GSI program 400 is that it can respond to all the requests, but not necessarily in real time.

The GSI program 400 controls the load balance and the distribution of players in the game rooms across multiple game servers 141-143 on which the game engine applications 300 reside. The GSI program 400 verifies that game rooms for a given game are not duplicated by accident. During the game sessions, the game client applications 200 updates the GSI program 400 with game statistics and game status information such as game scores, game equipment, game location. Tokens and validation keys can also be passed from the game engine application 300 to the game client applications 200 to make sure different actions are occurring in the correct order and are not being spoofed by the client game application 200. The game client application 200 may be required to return the tokens and keys combined with other variables to ensure that the game's integrity has not been compromised.

The GSI program 400 sends the game status information to database 150 and storage area network to store the game status information into the user account such that the user can keep his or her record even after the specific game session is ended.

An advantage of the present invention is that it allows scalability up to a large number of game players in the same game room or in different game rooms. The communications to the game client-applications are divided into persistent real-time communications and efficient but non-persistent communications. The amount of information communicated in real time is minimized. A flexible layer by game-system-interface (GSI) program handles the non-persistent communications, which allows the network-based game system to handle an ever-increasing number and variety of game client applications.

The GSI program 400 can also respond to requests from the game engine application 300 as shown in FIG. 5. The GSI program 400 provides information to the game engine application 300 as requested but the GSI program 400 does not initiate messages to the game engine application 300. The game engine application 300 informs the GSI program 400 of all players and game rooms created. The game engine application 300 also sends user ID, session ID, game room ID to the GSI program 400 for validation. The GSI program 400 responds to the game engine application 300 to validate of the game rooms, the game sessions and the user ID.

The game engine application 300 can communicate with the GSI application 400 over its own local host loop-back IP address (since the GSI program 400 can be installed and run on the same computer as the game engine application 300), eliminating network latency between the game engine application 300 and the GSI program 400.

The game client applications 200, the game engine application 300, and the GSI program 400 can securely communicate among each other in encrypted serialized messages. Each game engine application 300 can choose to communicate in specific serialization communication protocol such as PHP (Hypertext Preprocessor), XML, AMF, XML-RPC (Remote Procedure Call), etc. A library of serialization communication protocols is stored on a computer device connected to the network-based game system 100 available to the game engine application 300 and the GSI program 400. The library provides rules for encryption and decryption of the serialized messages under different protocols. The communication protocols can be independent of the game logic, the game rooms, and the game engine applications. In fact, the disclosed system allows different game client applications 200 using many different communication protocols to enter the same game room at the same time.

Although specific embodiments of the present invention have been illustrated in the accompanying drawings and described in the foregoing detailed description, it will be understood that the invention is not limited to the particular embodiments described herein, but is capable of numerous rearrangements, modifications, and substitutions without departing from the scope of the invention. The following claims are intended to encompass many such modifications.

What is claimed is:

1. A network-based game system, comprising:
a computer network;
a first server connected to the computer network, configured to store a game engine application that can communicate with a game client application running on a computer device connected to the computer network in a persistent network connection; and
a second server connected to the computer network, configured to store a game-system-interface (GSI) program that can respond to requests from the game client application running on the computer device.

2. The network-based game system of claim 1, wherein the game-system-interface (GSI) program is configured to communicate with the game client application running on the computer device in a non-persistent network connection.

3. The network-based game system of claim 1, wherein the game engine application is configured to be connected with the game client application in an open socket connection to allow messages to be instantaneously communicated between the game engine application and the game client application.

4. The network-based game system of claim 1, wherein the game client application is executed by a plug-in to a web browser installed on the computer device.

5. The network-based game system of claim 4, wherein the game client application uses the web browser's API to communicate with the game engine application and the GSI program.

6. The network-based game system of claim 1, wherein the game client application is configured to display vector-graphic animations independent of the web browser and can scale vector-graphic animations relative to the size of the web browser window.

7. The network-based game system of claim 1, wherein the game engine application and the game client application are configured to send requests to each other and instantaneously respond to the requests.

8. The network-based game system of claim 1, wherein the game engine application is configured to send animation information to the game client application.

9. The network-based game system of claim 1, wherein the GSI program is configured to receive game status information from the game client application running on the computer device.

10. The network-based game system of claim 9, wherein the game status information includes one or more of user identification, session identification, game room information, game statistics, and game configurations associated with a game client application running on the computer device.

11. The network-based game system of claim 10, further comprising a data storage system connected to the computer network, configured to store the game status information received from the GSI program.

12. The network-based game system of claim 1, wherein the GSI program is configured to send a verification message to the game engine application or the game client application in response to authentication information received from the game engine application or the game client application.

13. The network-based game system of claim 1, wherein the game engine program is configured to send identification information to the GSI program in response to the authentication information received from the game client application.

14. The network-based game system of claim 13, wherein the identification information includes one or more of user identification, game session identification, and game room identification.

15. The network-based game system of claim 1, wherein the game engine application and the GSI program are configured to communicate with the game client application in serialized messages encrypted under one or more serialization protocols.

16. The network-based game system of claim 15, further comprising a computer device connected to the computer network, configured to store a library of encryption rules and decryption rules to be used to encrypt and decrypt the serialized messages between the game client application and the game engine application or the GSI program.

17. The network-based game system of claim 16, wherein the library of encryption rules and decryption rules include a plurality of message serialization communication protocols.

18. A game architecture, comprising:
a computer network to be connected to a computer device capable of executing a game client application;
a first server connected to the computer network, configured to store a game engine application that can
a) respond to the game client application instantaneously after receiving a request from the game client application and
b) send a request to the game client application and instantaneously receive a response from the game client application; and
a second server connected to the computer network, configured to store a game-system-interface (GSI) program that can respond to the requests from the game engine application and can receive game information from the game engine application in a non-persistent network connection.

19. A method of providing a game over a computer network, comprising:
storing a game engine application on a first server connected to the computer network;
communicating between the game engine application and a game client application running on a computer device connected to the computer network in a persistent network connection;
storing a game-system-interface (GSI) program on a second server connected to the computer network; and
responding to requests from the game client application by the GSI program.

20. The method of claim 19, further comprising:
communicating with the game client application by the GSI program in a non-persistent network connection.
